(19) United States
(12) Patent Application Publication
(10) Pub. No.: US 2020/0410585 A1
(43) Pub. Date: Dec. 31, 2020

(54) ELECTRONIC SYSTEM AND METHOD FOR CLOUD FINANCING MANAGEMENT

(71) Applicant: FINHAUS LTD, London (GB)

(72) Inventors: Mark Austin, Sydney (AU); Gregory Martin Bartlett, Sydney (AU); Leonidas Koutsovasilis, Sydney (AU)

(21) Appl. No.: 16/915,475

(22) Filed: Jun. 29, 2020

(30) Foreign Application Priority Data
Jun. 28, 2019 (AU) 2019902303

(51) Int. Cl. G06Q 40/02; G06Q 10/10; G06Q 50/26; G06Q 30/00; G06Q 40/08; G06Q 50/16; G06F 16/27; H04L 9/32; G06F 21/60; H04L 29/06

(52) U.S. Cl. CPC G06Q 40/025; G06Q 10/10; G06Q 50/26; G06Q 30/018; G06Q 40/08; H04L 51/04; G06F 16/27; H04L 9/3247; G06F 21/602; H04L 63/0428; G06Q 2220/10; G06Q 50/16

(57) ABSTRACT

A computer system or method for facilitating a financial process of loan deal. A system or method for storing documents of a borrower securely and authorising lenders to access the requested documents. A system or method for automatically collecting, verifying, and update documents for a borrower and authorising lenders to access only the requested documents. It may be advantageous to provide for a system or method for matching a debt tender to a debt tender proposal. A system or method for matching multiple debt tenders to a single debt tender proposal. system or method for matching a single debt tender to multiple debt tender proposals.

### CROSS-REFERENCE TO RELATED APPLICATIONS

This application claims the benefit of and priority to Australian Patent Application No.: AU 2019902303, filed Jun. 28, 2019. The entire disclosure of which is herein incorporated by reference.

### BACKGROUND OF THE INVENTION

### Field of the Invention

The invention relates to an electronic system and method for cloud financing management. In particular, the present invention relates to an electronic system and method providing online services for borrowers and lenders to manage transactions for asset backed securities using distributed ledgers computer protocol. The system may be also implemented within a device or computer.

### Description of the Related Art

In the financial system of developed countries, a loan is typically the lending of money by one individual, organization, or other entity to another individual, organization etc. The recipient (i.e. the borrower) incurs a debt, and is usually liable to pay interest on that debt until it is repaid, and also to repay the principal amount borrowed This kind of private loan consist of high risk of default and the lenders have no guarantee that they can recoup their investment in case of default. Hence, typically, most lenders require the borrowers to provide tangible assets as collaterals. The asset backed loan using real property as collateral are known as mortgage.

Mortgage loans is an essential financial vehicle in modem society as most people can only purchase their homes through mortgage loan. Typically, mortgages are written by financial institutes to the borrowers with real properties as the collateral for a terms of 20 to 30 years. The interest of the mortgage can be a fixed rate or a variable rate based on the current cash rate. Typically, the financial institutes will keep the mortgage under its balance sheet for the entire terms of the mortgage loan.

The mortgage origination process usually begins with the submission of a mortgage application by an applicant to a lender. Typically, the mortgage application will end with either the closing status or non-closing status. A closing status signifies that the mortgage is approved by the lender and accepted by the applicant. A non-closing status means that the mortgage loan is rejected. This rejection can be raised by the lender, or by the applicant to an approved application.

As the terms of repayment of the mortgage loan is very long and the loan amount is usually two to twenty times over the annual average household income of a borrower, there are stringent investigations in the loan or mortgage origination on the borrower and the property to minimise the exposure of the financial institute. As a result, an application for a mortgage loan becomes a complex and lengthy exercise that involves a lot of data collection, verification, and validation. The loan interest for each case was reset and did not entirely reflect the risk exposure and the expected profit of each individual application. Consequently, the resulting mortgage loans given out are imbalance.

US Patent Published Application No. 20160140654 discloses an automated process workflow for the entire mortgage loan and closing process as a software service to automate the residential mortgage application. The software service is adapted to automating the mortgage application process by reconciling the extracted information to any trigger conditions in the database associated with the borrower documentation needed from the mortgage guidelines and the overlays to reinforce or verify the extracted information in the fields and forms by the borrower, and then generate a list of needed borrower documents that will be needed by the underwriter based on the guidelines of the government-sponsored lending institutions and the overlays required by direct lending corporations. This prior art system directs to the collection of borrower documents and comparing the documents with the mortgage guideline. However, it is not able to allow for searching of the optimised ban for one or more mortgage policies or vice versa.

U.S. Pat. No. 9,313,209 discloses a system mid method for loan origination and processing. This system resides on a computer server being coupled to a brokerage network that comprises a loan officer client, a loan processor client, and a broker manager client. Each brokerage client computer executes a unique interface to the loan origination and processing system. This prior art system merely provide a software for monitoring the process of the mortgage origination and alert the borrower of certain event. It is not also able to searching the optimised loan for one or more mortgage policies or vice versa.

U.S. Pat. No. 7,548,884 discloses a computer system to perform real estate transactions such as home sale, mortgage loan financing and settlement process, and the home mortgage loan refinancing and settlement processes. The system was adapted to receiving and displaying real estate transaction information comprising one or more of a real estate purchase criteria information and a loan criteria information. The system was also adapted to sorting and comparing information w herein each of the loan information, service information, and ownership cost information is associated with at least one of the real estate purchase criteria information, real estate information, or real estate pricing information whereby a buyer searches for and compares real estate, together with quotes, prices and terms for loans and services and the total cumulative costs of buying and owning real estate. This prior art system merely provide a software for monitoring the process of the mortgage origination and alert the borrower of certain event. It is not also able to searching the optimised loan for one or more mortgage policies or vice versa.

### SUMMARY OF THE INVENTION

The following is a summary of the invention in order to provide a basic understanding of some aspects of the invention. This summary is not intended to identify key or critical elements of the invention or to delineate the scope of the invention. The sole purpose of this section is to present some concepts of the invention in a simplified form as a prelude to the more detailed description that is presented later.

The present invention relates to a computer system or method for facilitating a financial process of loan deal.

It may be advantageous to provide for a system or method for storing documents of a borrower securely and authorising lenders to access the requested documents.

It may be advantageous to provide for a system or method for automatically collecting, verifying, and update documents for a borrower and authorising lenders to access only the requested documents.

It may be advantageous to provide for a system or method for matching a debt tender to a debt tender proposal.

It may be advantageous to provide for a system or method for matching multiple debt tenders to a single debt tender proposal.

It may be advantageous to provide for a system or method for matching a single debt tender to multiple debt tender proposals.

Other objects and advantages will become apparent when taken into consideration with the following specification and drawings.

It may be an object of the present invention to overcome or ameliorate at least one of the disadvantages of the prior art, or to provide a useful alternative.

In a first aspect of the present disclosure, there may he provided a method of recording a loan deal in a remote electronic database of an electronic system, comprising the step of: specifying a new loan requirement and submit a debt tender through a borrower portal interface rendered on a user device to a financial server; receiving one or more digital documents to the financial server, storing an encrypted copy of the digital documents in the remote database, and a digital signature of the digital document on a distributed ledger; generating a list of loan proposals from the loan proposals stored in the remote database and ranking the loan proposals on the list by one or more criteria; selecting a preferred loan proposal from the list of loan proposals on the user device; providing a digital access credential to access a subset of the digital documents; compiling a digital loan offer for accepting on a user device; and storing an accepted digital loan offer in the remote database and a digital signature of the accepted digital loan offer on a distributed ledger.

Preferably, the subset of digital documents comprises digital documents required by a lender to perform due diligence in assessing the loan proposal.

Preferably, the financial server comprises a government and industrial interface adaptor associated with a third party database management system for retrieving authenticated documents from a third party database.

Preferably, the distributed ledge comprises a blockchain data structure having for storing the digital signature of the documents.

Preferably, digital access credential comprises one or more temporary session keys for decrypting the documents.

Preferably, the government and industrial interface adaptor is adapted to periodically verily and update the documents.

Preferably, loan deal comprises one or more smart contracts to facilitate settlement transactions.

Preferably, the loan requirement comprises one or more of a debt entity, a fund entity, a property entity, property owner entity, existing debt entity, and lease entity.

Preferably, the criteria has a set range to the one or more entities.

Preferably, the step of generating a list of loan proposals comprises the steps of: extracting a loan amount attribute from a fund entity of the loan requirement: comparing the loan amount with the criteria of a loan proposal; in the event the loan amount is within the set range of a fund criterion, comparing other entities and corresponding criteria; in the event the other entities arc within the set range of the corresponding criteria, record the loan proposal on the list of loan proposals.

Preferably, in the event that the loan amount is above the set range of a fund criterion, the financial server is adapted to generate a loan syndicate with a plurality of loan proposals with an aggregated loan amount equal to the loan amount of the loan request.

Preferably, each of the plurality of loan proposals of the loan syndicate has a same value in the loan amount.

Preferably, the financial server comprises a support vector machine for analysing information from the remote database to generate one or more loan syndicate for a loan requirement.

Preferably, in the event that the loan amount is above the set range of a fund criterion, the financial server is adapted to generate a loan financing orchestration having a plurality of loan requirements with an aggregated loan amount equal to that loan amount of the loan proposal.

Preferably, the financial server comprises a support vector machine for analysing information from the remote database to generate one or more loan financing orchestration for a loan proposal.

Preferably, the method further comprises the step of recording a service provider arrangement for the loan deal in the remote database.

Preferably, the financial server is adapted to securitise a loan deal into a plurality of asset-back securities, store the asset-back security in the remote database, and a digital signature of the asset-backed security on a distributed ledger.

Preferably, the financial server is adapted to provide a chat collaboration interface for users to communicate offline and in real time vie an encrypted data channel.

In another aspect of the present invention, there is provided a user device connecting to a financial server comprising one or more processing unit in communication with each other to execute a method comprising the steps of: receiving a loan request matching lending criteria from the financial server; submitting a loan proposal to the financial server, receiving notification of loan proposal acceptance from the server; initiating loan book build and, if required, initiating loan syndication, loan securitisation and loan tokenization, wherein the loan syndication comprises a plurality of loan proposal having an aggregated loan amount equal to the loan amount of the loan request: providing loan approval; closing loan deal wherein the loan deal is recorded in a remote database and the digital signature of the loan deal is record on a distributed ledger.

Preferably, the method further comprises the steps of compiling a list of required documents for due diligent, requesting the financial server for an access credential for the list of required documents, and using the access credential to retrieve the list of required documents from the remote database.

### BRIEF DESCRIPTION OF THE DRAWINGS

FIG. 1 is a system architecture design diagram of an electronic system of an embodiment of the present invention.

FIGS. 2A-2C depicts a use ease diagram of the electronic system of FIG. 1.

FIG. 3 is an entity-relationship diagram of a property entity in the electronic system of FIG. 1.

FIG. 4 is an entity-relationship diagram of a debt entity in the electronic system of FIG. 1.

FIG. 5 is an entity-relationship diagram of a fund entity in the electronic system of FIG. 1.

FIG. 6 is an entity-relationship diagram of a property lease entity in the electronic system of FIG. 1.

FIG. 7 is an entity-relationship diagram of a loan tender in the electronic system of FIG. 1.

FIG. 8 is an entity-relationship diagram of a service tender in the electronic system of FIG. 1.

FIG. 9 is a process flow diagram of the borrower process of recording a new loan in the electronic system of FIG. 1.

FIG. 10 is a process How diagram of the lender process of recording a new loan in the electronic system of FIG. 1.

FIG. 11 is a screen shot diagram of a debt tender interface of the electronic system of FIG. 1.

FIG. 12 is another screen shot diagram of the tender interface of FIG. 11.

FIG. 13 is yet another screen shot diagram of the tender interface of FIG. 11.

FIG. 14 is a screen shot of a dashboard interface of the electronic system of FIG. 1.

### DESCRIPTION OF THE PREFERRED EMBODIMENT(S)

The following detailed description and disclosure illustrates by way of example and not by way of limitation. This description will clearly enable one skilled in the art to make and use the disclosed systems and methods, and describes several embodiments, adaptations, variations, alternatives and uses of the disclosed systems and methods. As various changes could be made in the above constructions without departing from the scope of the disclosures, it is intended that all matter contained in the description or shown in the accompanying drawings shall be interpreted as illustrative and not in a limiting sense.

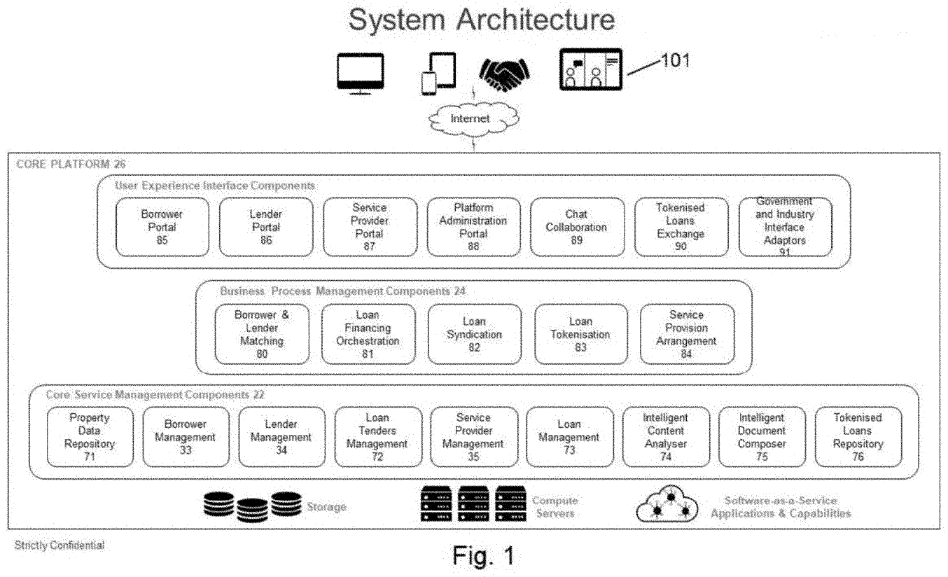

Reference is made to FIG. 1 which shows a schematic diagram of an embodiment of the present invention. The electronic system for cloud financing management 10 an embodiment of the present invention comprises one or more computer servers 12 connecting to a data storage 14. In one embodiment, the computer server 12 comprises one or more electronic processing units connected with one another, and the data storage is a distributed data warehouse comprising one or more non-volatile storage devices connected to each other.

The computer server 12 provides a platform for delivering software as a service (SaaS) application to carrying out one or more functions of the electronic system 10 of an embodiment of the present invention. The electronic system 10 further comprises a financial management server 16 for providing a financial server to one or more stakeholders, such as borrowers (also refer to as mortgagors), lenders (also refer as mortgagees), and service providers.

In one embodiment, the financial server 16 comprises one or more load balancing devices adapted to receiving requests from client devices. The requests can be in the form of application programming interface calls, hypertext transport protocol requests, remote procedural calls, etc. The load balancing processors will not handle the requests but divert the request to one of the request processing units to handle the requests. In one embodiment, the load balancing devices comprises any one or more processing units, firewall, network routers, and network switches.

In one embodiment of the present invention, a processing unit comprises one or more control units and an arithmetic f logic units associated with a local memory or cache for executing one or more threads of digital operations. The processing unit further comprises a memory subsystem including computer storage media in the form of volatile and/or non-volatile memory such as read-only memory (ROM) and random access memory (RAM).

In one embodiment of the present invention, the ROM is hardcoded with a basic input/output system (BIOS), containing the bask functions to transfer information between elements within a processing unit, such as during start-up. The BIOS will load data, application modules or components that are immediately accessible to and/or presently being operated on by processing unit into the RAM.

In one embodiment of the present invention as show n in FIG. 1, the application components of the electronic system 10 is divided into three groups, namely: core service management components 22, business process management components 24, and user experience interface components 26.

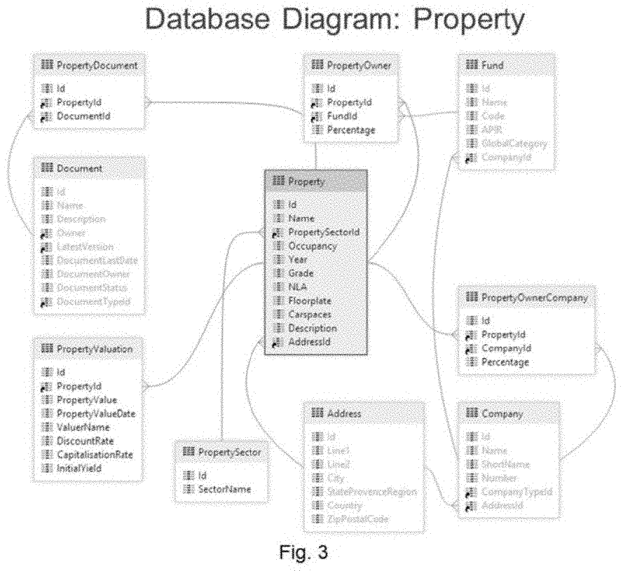

The core service management components 22 provides the function of managing the core information management for in the loan origination process. It comprises a property data repository 32 for storing property data to the data storage 14. In one embodiment, the properly data repository 32 comprises one or more software agents that is adapted to search, download, and update property data periodically from a number of third party service providers, such as builders, real estate agent, strata management agents, property evaluators, land title office, and/or local councils. FIG. 3 shows a data schema of the property data stored in the data storage 14 in an embodiment of the present invention.

The core service management components 22 also a user management module that allows a user to log in and log off the electronic system 10. The user management system is adapted to connect to the data storage 14 to verify the identity of the user, the user profile, and/or provide the access credential or token for the user to carry out one or more actions within the electronic system 10.

A user may have one or more roles such as borrower, lender, or service provider. These system roles are not mutually exclusive such that a user may be a borrower and a lender at the same time. The access credential or token of a user is used to determine whether a user is allowed to access the functions of a particular role. The user can be a person, an institute, a state, etc. and the data requirement for each user may be different. For example, the user may be a corporation. In this event, the software agent of the electronic system 10 will search and fetch the incorporation profile of the user and stored the data in the database 14. In one embodiment, the software agent is adapted to collect information related to the incorporate including the date of incorporation, director identity, director credit rating, etc.

The core service management components 22 comprises a borrower management interface 33 for carrying out borrower management functions, a lender management interface 34 for carrying out borrowing functions, and a service provider management interface 35 for carrying out service provider functions as shown in FIG. 1.

In one embodiment, the borrower management interface 33 is rendered by a computer server 12 of the electronic system 10 as a borrower portal 85 on a user dev ice 101. The lender management interface 34 is rendered by a computer server 12 of the electronic system 10 as a lender portal 86 on a user device 101. T he service provider management interface 35 is rendered by a computer server 12 of the electronic system 10 as a borrower portal 87 on a user device 101. When a user device sends a digital request to access the borrower management interface 33, the lender management interface 34, or the service provider management interface 35, the computer server 12 is adapted to request the collect the browser or device fingerprint to determine the optimal display format for the user dev ice. The computer server 12 will render the borrower portal 85, lender portal 86, or service provider portal 87 based on the device fingerprint.

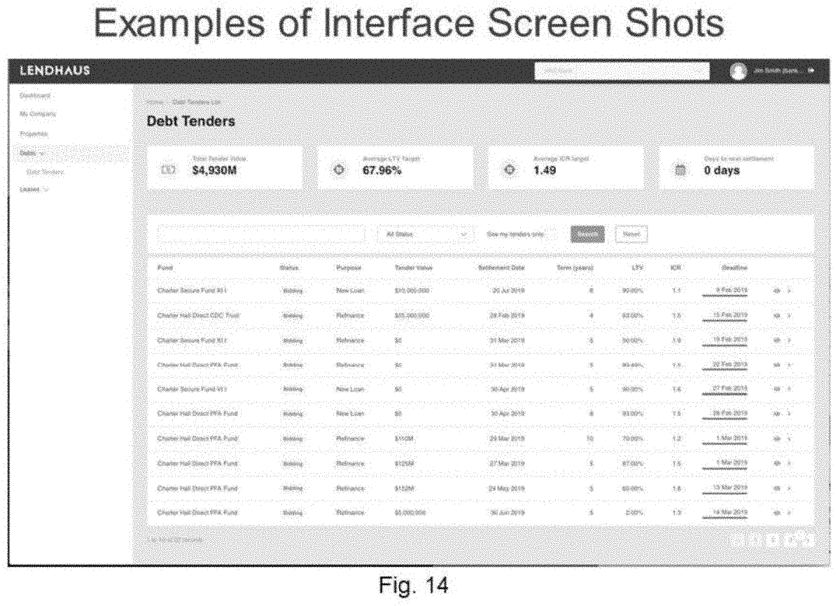

In one embodiment, a user with a borrower credential can access the borrow management interface 33 as shown in FIG. 14, and a user with a lender credential can access the lender management interface 34 as shown in FIG. 15. A user with service provider credential may access the service provider interface 35.

In one embodiment of the present invention, the computer server 12 is adapted to provide a platform management portal 88 for a user to carry out system administration for the electronic system 10. Each role in the electronic system 10 may have a different security token, and hence while the system administrator may access most of the function in the system, the system administration access token does not provide the authority to access user private or financial data. The platform management portal 88 may provide the interface for the system administrator to back up the system in the data storage 14 or back up the system in a physical media to store in a remote location.

In one embodiment, the platform administration portal 88 provides a distributed ledger management interfaces for controlling the distributed ledgers and smart contracts used in the electronic system 10. In one embodiment, the platform administration portal 88 is adapted to manage the consensus rules for running the distributed ledgers and smart contracts.

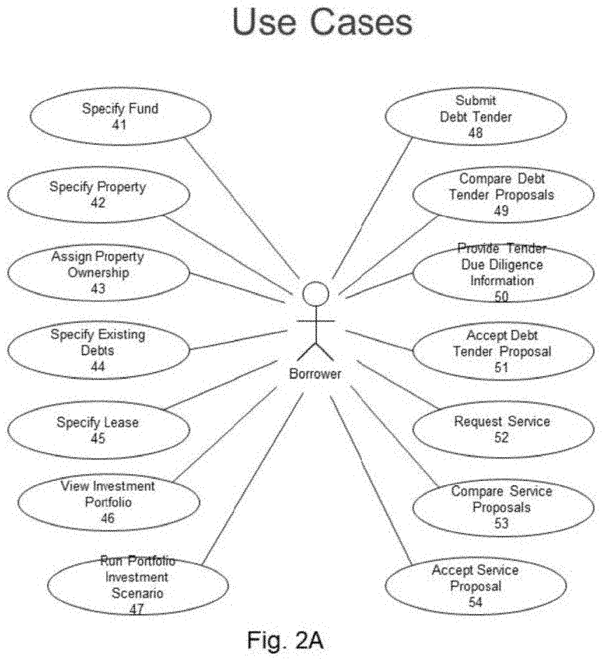

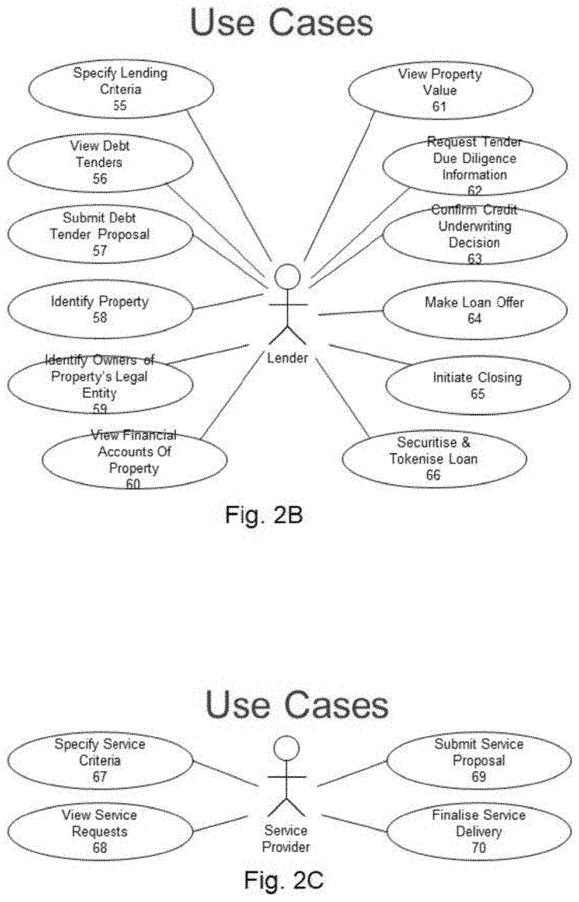

Referring to FIGS. 2A-2C, there is provided a schematic diagram of the user eases of an embodiment of the present invention. FIG. 2A shows a use ease diagram of a user accessing the borrower interface 33.

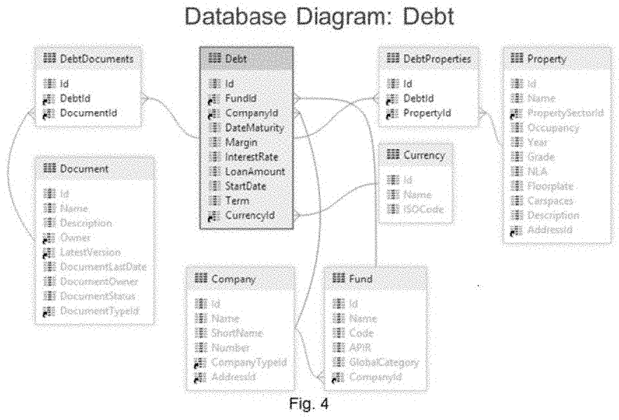

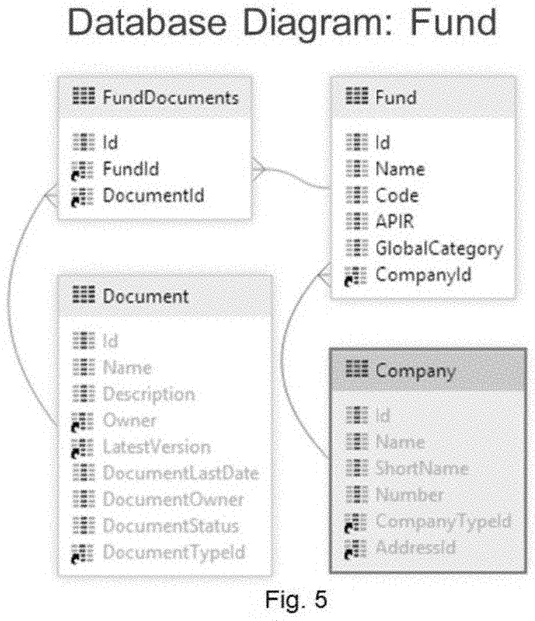

The borrower interface 33 is adapted to provide a fund specification interface for entering data relating to a fund required by a user. The fund specification interface is adapted to invoke a specify fund function call 41 loaded to the memory of the electronic system 10. The specify fund function call will capture the fund data entered by the user and stored them in the data storage 14. FIG. 4 and FIG. 5 show an example of fund data schema of an embodiment of the present invention.

The borrower interface 33 is adapted to provide a property specification interface for entering data relating to a property of a loan. The property specification interface is adapted to invoke a specify property function call 42 loaded to the memory of the electronic system 10. T he specify property function call 42 will capture the property data entered by the user and stored them in the property dam repository 71 of the data storage 14.

Once a property data is entered, the property data repository 71 will periodically update by software agents managed by the financial server 16 to search, update, and verify data related to the property. Some of the data arc associated with a set of business rules and the electronic system 10 will alert a user when the data are outside the criteria of the business rules. For example, the property may be originally designed in a particular zone, such as low density. The software agents of the financial server 16 may periodically check the zoning of the property by fetching data from a local council. The electronic system 10 may alert the users when the zoning of the property changed, such as from low density to commercial which affects the valuation of the property. In another embodiment, the software agents are adapted to fetch the environment data of the property. The environment data is related to the location of the property which can be used for valuation and risk assessment. The environment data may include the security rating of the property location, demography, economy, etc.

The borrower interface 33 is adapted to provide an assign property ownership interface for entering ownership data relating to a property of a loan. The assign property ownership interface is adapted to invoke an assign property ownership function call 43 loaded to the memory of the electronic system 10. The assign property ownership function call 43 will capture the property ownership data entered by the user and stored them in the property data repository 71 of the data storage 14.

The software agents managed by the financial server 16 will search and fetch the property ownership data from a land title office to verily the property ownership data in order to keep the property data stored in the property data repository up-to-date. In the event, that the property ownership is not recorded in a registry of a land registration and land transfer system, the electronic system 10 will alert the user to collect and scan the original title deeds into the data storage 14. In one embodiment of the present invention, the assign property ownership interface is adapted to capture other interests under the property title such as caveats and casements.

In an embodiment of the present invention, the electronic system 10 is adapted to receive documents from a number of sources, such as from a government institute, financial institutes, agency, users, etc. FIG. 3 and FIG. 4 shows a data schema for storing document entity in the data storage 14. The document data schema comprises one or more attributes of identification number, name, description, owner, version, create timestamp, update timestamp, author, source, status, type, security information etc.

The scanned documents may be certified and stored in a secured distributed ledger system as a proof of authenticity by the intelligent document composer. In one embodiment, the storing data or scanned document of the present invention may be earned out by the intelligent document composer comprising the steps of generating a digital signature of the data to be stored, creating a block for storing the digital signature in a distributed ledger, storing the block number and/or header, the data, the digital signature in the data storage 14. The data stored in the data storage 14 may be encrypted and will only accessible with the authenticated access token. Hence, the data or scanned document remains in the data storage 14 and only a hash or digital signature of the data or scanned document is stored in the distributed ledger. For simplicity of this application, we refer the process as storing the data or the scanned document in a distributed ledger.

The borrower interface 33 is adapted to provide a specify existing debts interface for entering data relating to the existing debts of the borrowers. The specify existing debts interface is adapted to invoke a specify existing debts function call 44 loaded to the memory of the electronic system 10. The specify existing debts function call 44 will capture the existing debts data entered by the user and stored them in the data storage 14. FIG. 4 shows an example of the schema for storing existing debts data and related data in the data storage 14.

The existing debts may include current mortgage, secured and unsecured personal loan, credit card debt, etc of the borrower. The debt data can be historical data to capture any debts taken out by the borrower in the past ten to one year. The software agents of the electronic system 10 will search and fetch other relevant debt information of the borrowers from a third party data provider such as a credit rating company. The debt relevant information may include the current and historic credit rating of the borrowers.

In one embodiment of the present invention, the existing debt information is used to generate a credit rating of a user by the intelligent content analyser 74.

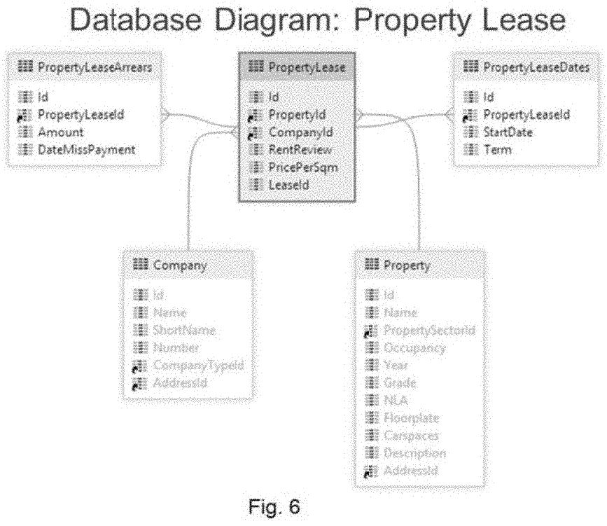

The borrower interface 33 is adapted to provide a specify lease interface for entering data relating to the lease of the property for a loan. The specify lease interface is adapted to invoke a specify lease function call 45 loaded to the memory of the electronic system 10. The specify lease function call 45 will capture the current and historical data entered by the user and stored them in property data repository 71 of the data storage 14. The software agent managed by the financial server 16 will search and fetch the current and historic lease data from a third party database such as real estate agent database. FIG. 6 shows the schema for properly lease and related data of an embodiment of the present invention.

The borrower interface 33 is also adapted to provide a view investment portfolio interface for displaying the investment portfolio of a user. The view investment portfolio interface is adapted to invoke a view investment portfolio function call 46 loaded to the memory of the electronic system 10. The view investment portfolio function call 46 will search the mortgages, loan, and oilier financial investment of a user from the data storage 14 and cause to display these data to display on the view investment portfolio interface.

The borrower interface 33 is adapted to provide a run portfolio investment scenario interface for running a simulation of a property investment scenario. The run portfolio investment scenario interface is adapted to invoke a run portfolio investment scenario call 47 loaded to the memory of the electronic system 10. The run portfolio investment scenario function call 47 will run a simulation to project the future of the property investment in different scenarios such as fix interest rate against flexible interest rate, different CPI. fluctuation of foreign currency exchange rate, economic downturn, change in income and rental, etc. In one embodiment, run portfolio investment scenario function call 47 will fetch a set of predetermined parameters from the data storage 14 for a number of scenarios and/or loan plan (debt proposals), and generate a number of corresponding scenario data packages.

The run portfolio investment scenario function call 47 then folks an application programming interface (API) call for each scenario data package and request the computer server 12 to handle the simulation. Typically, the computer server 12 is a distributed computing server network location remotely to the financial server 16. Each API call to the computer server 12 may consume a certain among of system resources. The financial server 16 may deduct an amount of credit or currency from the user running the portfolio investment scenario.

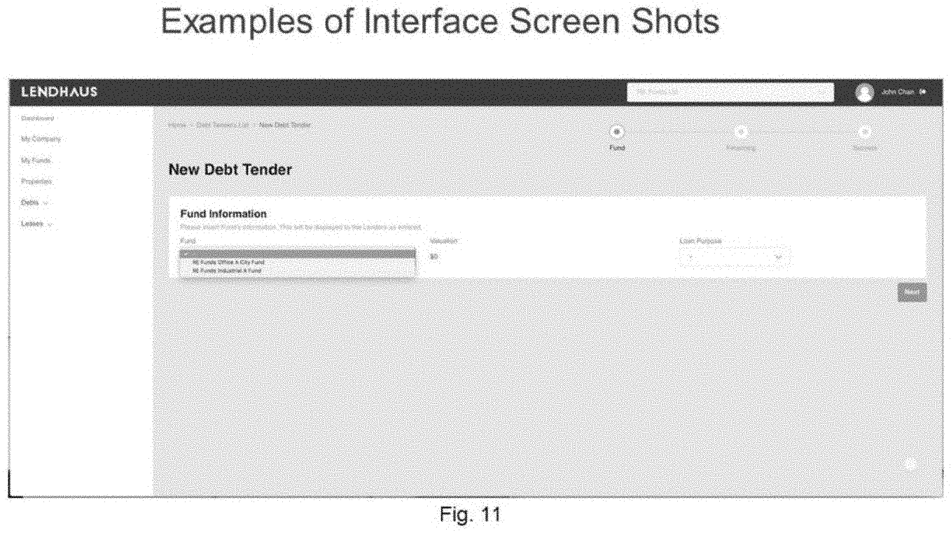

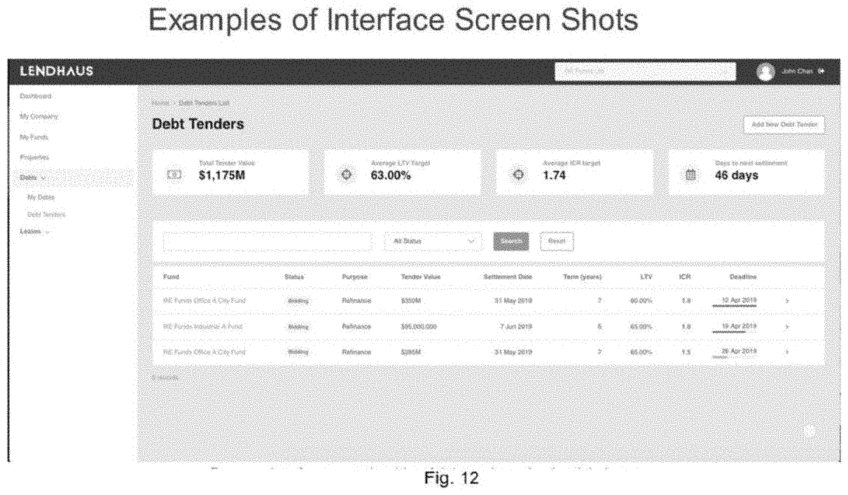

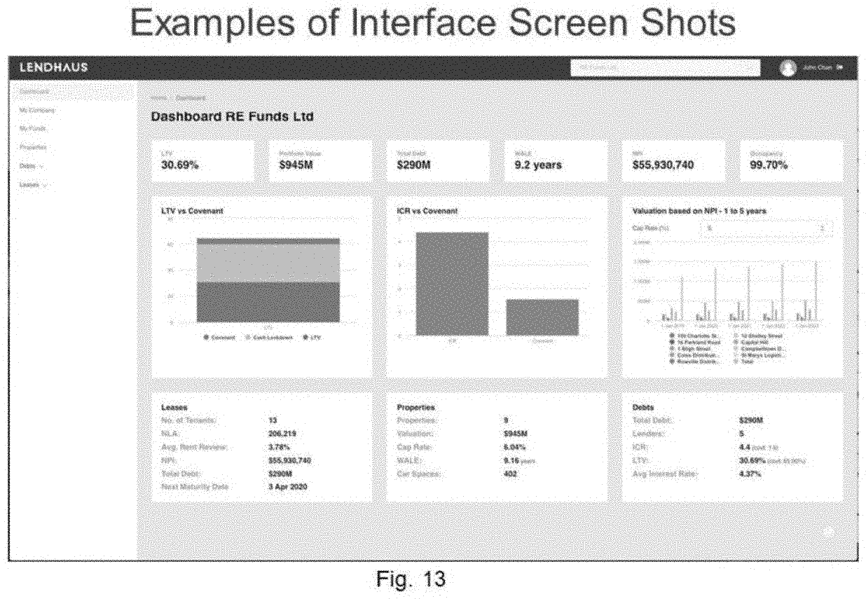

The borrower interface 33 is also adapted to provide a submit debt tender interface for submitting a debt tender to one or more lenders. The submit debt tender interface is adapted to invoke a submit debt tender function call 48 loaded to the memory of the electronic system 10. FIG. 11, FIG. 12 and FIG. 13 show the screen shots of a debt tender user interface rendered on a user device 101.

In one embodiment, the user interface of an embodiment of the present invention comprises a multiple panes design as shown in FIG. 11. The menu pane is located on the left side of the user interface and the content pane is located on the right side of the user interface. The menu pane comprises a user interface to switch the content in the content pane. For example, the menu pane has a dashboard user button to change the content of the content pane to the dashboard as shown in FIG. 14. In another embodiment, the user interface design is more compact to accommodate handheld devices.

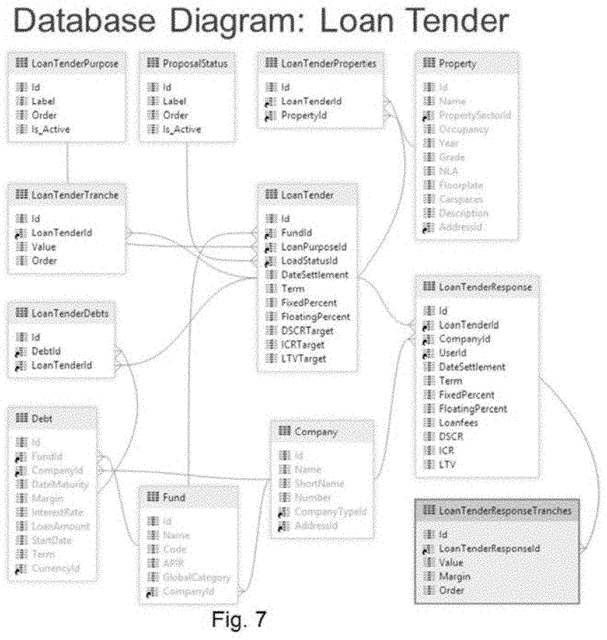

The submit debt tender function call 48 will capture the loan tender data from the user to store in the data storage 14 and generate a debt tender proposal forward the proposal to the lender. FIG. 7 shows the schema of the loan tender and related data of an embodiment of the present invention.

The electronic system 10 provides a loan tender management interface 72 for a user to manage the tender data. The tender management interface 72 is adapted to retrieving tender data and rendering a standard tender document for a user using the intelligent document composer 75. The rendered tender document can be presented digitally on a user device 101 in accordance with the display screen resolution of the user device. The rendered tender document can also be presented digitally to a computer printer for priming out a hard copy.

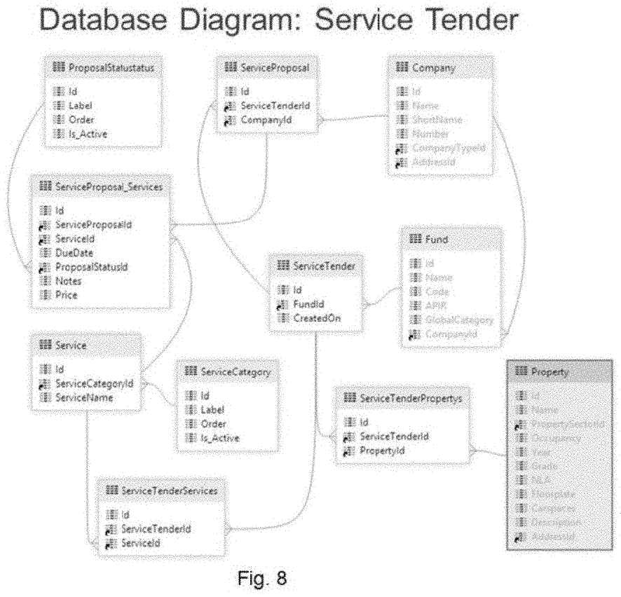

In one embodiment, the loan tender data is authenticated and stored in a distributed ledger by the tender management interface 75. The data schema of the load tender data is shown in FIG. 8. When a user submits a debt tender to a lender, the submit debt tender function call 48 will also generate a credential token to allow the lender to access a number of documents of the user stored in the data storage 14.

The borrower interface 33 is also adapted to provide a compare debt tender proposals interface for displaying the investment portfolio of a user tor comparison. The compare debt lender proposals interface is adapted to invoke a compare debt tender proposals function call 49 loaded to the memory of the electronic system 10. The compare debt tender proposals function call 49 will search a number of debt tender proposals for the user from the data storage 14 and cause the proposals to display on the compare debt lender proposals interface. The compare debt tender proposals interface also provides a number of graphing tools for a user to compare the debt tender proposal visually. In one embodiment, the financial server 16 provides one or more proposal comparison tool application programming interlaces. These comparisons will cause the comparison algorithm of the proposal to be run on the remote server or computer server 12 with reference to the big data stored in the data storage 14. The compare debt tender proposals interface is also adapted to allow a user to compare scenario projections of the proposal.

The borrower interface 33 is also adapted to provide a provide tender due diligence information interface for a user to submit information and documentation for lender due diligence process. The provide tender due diligence information interface is adapted to invoke a provide tender due diligence information function call 50 loaded to the memory of the electronic system 10. The tender due diligence information function call 50 may seek permissions front the user to access a number of personal documents far due diligence. The financial server 16 will search the data storage 14 for existing documents, then the financial server will send out software agents to search and fetch due diligence data of the user from third party databases, such as government database, real estate agent databases, local council database, etc.

The financial server 16 of the present invention comprises one or more government and industry interface adaptors 94 for to search and fetch data of the user from third party databases, such as government database, real estate agent databases, local council database, etc. The government and industry interface adaptors 94 of the present invention may be implemented as autonomous software agents or middleware. In either form, the government and industry interface adaptors 94 is adapted to receive one or more consensus rules to schedule the searching and fetching of data from the third party database. The data can be received either by a push or pull mechanism. The government and industry interface adaptors 94 comprises one or more threads in searching and retrieving data and an individual exclusive electronic memory space for storing temporary information received.

The provide tender due diligence information interface is also adapted to allow a user to upload new documents to the user profile. These new documents and information will be authenticated and stored in a distributed ledger. The financial server 16 may also have software agents periodically verify and validate the currency of the due diligence information.

The borrower interface 33 is also adapted to provide an accept debt lender proposal interface for a user to review and submit an acceptance notice for a debt tender proposal to a lender. The accept debt tender proposal interface is adapted to invoke an accept debt tender proposal function call 51 loaded to the memory of the electronic system 10. The accept debt tender proposal function call 51 will request the user to authorise a lender to access a number of due diligence information. In one embodiment of the present invention, this is done by providing a lender with an access control token including a number of security keys for proof of authority.

The borrower interface 33 is also adapted to provide a request service interface for a user to request service information or proposals from a lender. The request service interface is adapted to invoke a request service function call 521 loaded to the memory of the electronic system 10. The request service function call 52 will fetch a number of general service information and proposal from the lender and delivers to the user for review. The request service interface is also adapted to allow a user to specify any particular service request arrange and submit to the service provider. In one embodiment, the request service interface provides a message or chatting dialogue box for a borrower and a lender to communicate directly in real time. In one embodiment of the present invention, the real time message exchange interface function is handled by the chat collaboration interface 94.

The request service interface is also adapted to allow a user to list and view a number of service proposals provided by a lender. Each of the proposals may have a due date and a user cannot accept any proposal that passes the due date. FIG. 8 shows the schema for service proposal and related data of an embodiment of the present invention.

The borrower interface 33 is also adapted to provide a compare service proposals interface for a user to compare different service proposals available. The compare interface is adapted to invoke a compare service proposals function call 53 loaded to the memory of the electronic system 10. The compare service proposals function call 53 will search a number of service proposals for the user from the data storage 14 and cause the proposals to display on the compare service proposals interface. The compare service proposals interface also provides a number of graphing tools for a user to compare the debt tender proposal visually.

The borrower interface 33 is also adapted to provide an accept sendee proposal interface for a user to review and submit an acceptance notice for a sendee proposal to a lender. The accept service proposal interface is adapted to invoke a accept service proposal function call 54 loaded to the memory of the electronic system 10. The accept service proposal function call 54 will request the user to authorise a lender to access a number of due diligence information. In one embodiment, this is done by providing a lender with an access control token including a number of security keys for proof of authority.

Referring to FIGS. 2A-2C, there is provided a schematic diagram of the user cases of an embodiment of the present invention. FIG. 2B shows a use case diagram of a user accessing the lender management interface 34. The lender management interface 34 is adapted to access the loan management interface 73 for managing loan portfolio. Through the loan management interface 73. the lender can view, search, update the loan data from the data storage 14. The loan management interface 73 also allows the lender to access the intelligent content analyser for running scenarios, projects, simulations, with the big data stored in the data storage. In one embodiment, a lender may not access data of another lender, but the big data includes all anonymised data stored in the data storage 14. As such, each user may benefit from the aggregate result of all data in the electronic system 10 of the present invention without compromising the privacy of other users.

The lender interface 34 is adapted to provide a specify lending criteria interface for entering lending criteria of a lender. The specify lending criteria interface is adapted to invoke a specify lending criteria function call 55 loaded to the memory of the electronic system 10. The specify lending criteria function call 55 will capture the lending criteria data entered by the user and stored them in the data storage 14. In one embodiment, the financial server 16 allows a lender to specify the lending criteria as one or more set of business rules in the form of a protocol in computer instructions or languages such as Solidity, javascript. Simplicity, python, Rholang, etc. In another embodiment, the lending criteria is specified as a form of smart contracts which can be automatically triggered w hen the criteria arc satisfied.

The lender interface 34 is adapted to provide a view debt tenders interface for searching and viewing debt tenders records. The view debt tenders interface is adapted to invoke view debt tenders function call 56 loaded to the memory of the electronic system 10. The view debt tenders function call 56 will capture the searching criteria from a user, retrieve the debt tender records from the data storage 14, and display the debt tender records to the user.

The lender interface 34 is adapted to provide a submit debt tender proposal interface for preparing and sending a debt tender proposal to a borrower. The submit debt tender proposal interface is adapted to invoke a submit debt tender proposal function call 57 loaded to the memory of the electronic system 10. The submit debt tender proposal function call 57 will first verily the debt tender proposal comply with the lending criteria and then send it to the borrower. In one embodiment, the debt tender proposal record is encrypted with a security key of the borrower and can only be decrypted by the borrower for further processing. The security key can be a session key or a public key.

The lender interface 34 is adapted to provide an identify property interface fora user to search a property and display the information relative to the property. The identify property interface is adapted to invoke an identify property function call 58 loaded to the memory of the electronic system 10. The identify property function call 58 will capture the property data entered by the user and search the property data from the data storage 14. If the electronic system 10 is unable to find the property information from the data storage 14, the electronic system will send out one or more software agents to collect the property data from one or more third party databases. FIG. 3 shows the schema of the property and property related data of an embodiment of the present invention.

The lender interface 34 is adapted to provide an identify owners of the property's legal entity interface for searching, collecting, and verifying ownership data relating to a property. The identify owners of the property legal entity interface is adapted to invoke an identify owners function call 59 loaded to the memory of the electronic system 10. The identify owners function call 59 will search the ownership data from the data storage 14. If the electronic system 10 is unable to find the owners's information of the property from the data storage 14, the electronic system will send out one or more software agent to collect the property data from one or more third party databases. In one embodiment, the identify property interface can invoke a identify owners function call 59 automatically without going through the identify owners of the property's legal entity interface.

The lender interface 34 is adapted to provide a view financial accounts of property interface for viewing the financial accounts information. The view financial accounts of property interface is adapted to invoke a view financial accounts of property function call 60 loaded to the memory of the electronic system 10. The view financial accounts of properly interface function call 60 will search the financial account data from the data storage 14 and display to the user. In one embodiment, the view financial accounts of property interface is adapted to allow a user to simulate and project the financial status of a property over the entire loan period or in a particular loan period under different economic models and scenarios. In one embodiment of the present invention, the software agents of the electronic system 10 are adapted to periodically run simulation and projection of the financial status of the property based on the current economic status and alert a user when the financial account satisfies or fails to satisfy certain criteria.

The lender interface 34 is adapted to provide a view property value interface for searching, collecting, and verifying property value data relating to a properly. The view property value interface is adapted to invoke view property value function call 61 loaded to the memory of the electronic system 10. The view property value function call 61 will search the property value data from the data storage 14. If the electronic system 10 is unable to find the property value information of the property from the data storage 14, the electronic system will send out one or more software agents to collect the property value data from one or more third party databases. In one embodiment, the identify property interface can invoke the view property value function call 63 automatically without going through the identify owners of the property's legal entity interface. In another embodiment, the electronic system 10 will use the big data resided in the data storage 14 to generate a property value model and calculate an estimate property value based on the generated property value model. In one embodiment, the electronic system 10 will send out a request to a third party service provider to provide an estimated value of the property.

The lender interface 34 is adapted to provide a request tender due diligence information interface. The request lender due diligence information interface is adapted to invoke request tender due diligence information function call 62 loaded to the memory of the electronic system 10. The request tender due diligence information function call 64 will send a request to the borrower to carry out tender due diligence. Typically, the request tender due diligence information function call 62 is invoked automatically before confirming a credit underwriting decision. In one embodiment, the request tender due diligence information function call 64 will request the borrower to provide a security key or token to access private or confidential information of the borrower.

The lender interface 34 is adapted to provide a confirm credit underwriting decision interface. The confirm credit underwriting decision interface is adapted to invoke confirm credit underwriting decision function call 65 loaded to the memory of the electronic system 10. The confirm credit underwriting decision call 63 will send a confirmation message to the borrower indicating the loan is confirmed. Before a loan is confirmed or before invoking the confirm credit underwriting decision function call 63, the electronic system 10 will check and verify all the loan criteria have been satisfied, the confirm credit underwriting decision call 65 will change the status of the borrower and the loan such that the financial server can invoke the initiate closing function call 65. In one embodiment, the credit underwriting decision is recorded and stored in a distributed ledger.

The lender interface 34 is adapted to provide a make loan offer interface. The make loan offer interface is adapted to invoke a make loan offer function call 64 loaded to the memory of the electronic system 10. The make loan offer function call 64 is adapted to capture user information of loan criteria and generate a loan offer for sending out to one or more borrowers. In one embodiment, the loan offers are encrypted with a security key such that only the target borrower with the decryption key can read the loan offer.

The lender interface 34 is adapted to provide an initiate closing interface. The initiate closing interface is adapted to invoke an initiate closing function call 65 loaded to the memory of the electronic system 10. The initiate closing function call 65 is adapted to generate a series of procedure for closing a loan application. These procedures will be generated based on the business rule and lending criteria specified by the lender such that it will comply with the requirements of underwriting a loan. The initiate closing function call 67 may invoke one or more software agents to verify and validate the due diligence information before transferring the credit for settlement.

The lender interface 34 is adapted to provide a securitise and tokenise loan interface 66. The securitise and tokenise loan interface 66 provides an interface for the lender to create, manage, purchase, sell, discharge, or amortise an asset backed securities or tokens in the form of tokenised loan data. The securitise and tokenise loan interface 68 allows a lender to view the loans and select one or more loans for securitisation. The tokenised loans data are stored in the tokenised loans repository 76 of the data storage 14. In one embodiment, the tokenised loans data are stored in a distributed ledger using cryto-coin or cryto-token. In one embodiment, the electronic system 10 maintains its own private ledger and cryptocurrency which is known as crypto-coin. In another embodiment, a public crypo-token such as ethereum is used. The cryptocurrency is used to pay the cost for the transactions of the distributed ledger.

In one embodiment, the user experience component 26 of the electronic system 10 provides a tokenised loan exchange interface 90 for rendering a user interface on a user device 10 for a user to manage and trade the tokenised loans. The business process management components 24 of the electronic system 10 provides a loan tokenisation interface 83 for carrying out the process of the loan tokenisation. In one embodiment, the loan tokenisation interface 83 is adapted to call the intelligent content analyser 74 to analyse the loan tokenisation information stored in the data storage 14 with support vector machine and deep learning neural network to optimise the loan selection and tokenisation steps of the loan tokenisation process.

Referring to FIGS. 2A-2C, there is provided a schematic diagram of the user cases of an embodiment of the present invention. FIG. 2C shows a use case diagram of a user accessing the service provider interface 35. The service provision arrangement interface 84 will provides the application programming interfaces for a user to define business rules govern a service arrangement. In one embodiment, the service provision arrangement interface 84 allows a user to define the service business rule in the form of smart contracts.

The service provider interface 35 is adapted to provide a specify service criteria interface for entering service criteria of a lender. The specify service criteria interface is adapted to invoke a specify service criteria function call 67 loaded to the memory of the electronic system 10. The specify service criteria function call 67 will capture the service criteria data entered by the user and stored them in the data storage 14. In one embodiment, the financial server 16 allow a lender to specify the service criteria as one or more set of business rules in the form of a protocol in computer instructions or languages such as Solidity, javascript. Simplicity, python, Rholang, etc. In another embodiment, the service criteria arc specified as a form of smart contracts which can be automatically triggered when the criteria arc satisfied.

The service provider interface 35 is adapted to provide a view service requests interface for searching and viewing service request records. The view service requests interface is adapted to invoke view service requests function call 68 loaded to the memory of the electronic system 10. The view service requests function call 68 will capture the searching criteria from a user, retrieve the service request records from the data storage 14, and display the service request records to the users.

The service provider interface 35 is also adapted to provide a submit service proposal interface for submitting a service proposal to one or mom users or mortgagees. The submit service proposal interface is adapted to invoke a submit service proposal function call 69 submit the service proposal to one or more users or mortgagees. In one embodiment, the submit service proposal interface comprises a real time dialog box for the server provider to communicate and transfer digital data with the user or mortgagee in real time. The service proposal may comprise one or more business rules regarding collection of interest, principal, and escrow payments from borrowers. The level of service may be specified in the service proposal depending on the type of loan and the terms.

The service provider interface 35 is adapted to provide a finalise service delivery interface for completing the mortgage service procedures. The submit service proposal interface is adapted to invoke a final service delivery function 70 for delivering mortgage services. In one embodiment of the present invention, mortgage services are delivery by a number of software agents in the financial service 16. These software agents scheduled to collect payment from various borrows bank account. The software agent may dynamically store the application programming interface of a mortgagor's bank account and the repayment data. At each payment period, the software agent is adapted to invoke the mortgagor's bank account to carry out payment transaction automatically. The software agent may then invoke the bank application programming interface of the mortgagor's or asset backed securities holders to remit the collected payment to various parties, including paying taxes, stamp duties, and insurance from escrowed funds, remitting principal and interest payments, and remitting fees to mortgage guarantors, trustees, and other third parties providing services.

In one embodiment of the present invention, the business process and management components 24 provides the borrower and lender matching interface 80, loan financial orchestration interface 81, and loan syndication interface 82.

In one embodiment of the present invention, there is provided a borrower and lender matching interface 80 for matching borrower and lender pair. In one embodiment, the borrower and lender matching interface 80 generates a database query for a lender or a borrower that satisfy all the requirements in the data storage 14. This matching method can guarantee that the result pairs will satisfy all criteria and loan approval. However, this method suffers the disadvantage that it may be difficult to find a matching pair.

In another embodiment, the borrower and lender matching interface 80 will set a tolerant range and priority for each of the criteria such that a borrower who falls within the tolerant range may be considered as potential matches. After a list of potential matches is generated, the borrower and lender matching interface 80 will identify all the non-compliance properties of the borrower and alert the borrower accordingly. The borrower and lender matching interface 80 may rank the different pairs by the probability of successful expectation in accordance with the priority of the criteria. If a non-compliance criterion is assigned with low priority, such as request fund is slightly lower, the calculated probability of successful expectation will be relatively higher.

In one embodiment, the tolerant range and criteria priority is specified by the borrower or lender. In another embodiment, the tolerant range is generated by the intelligent content analyser 74 based on the previous accepted and rejected loan records stored in the data storage 14.

In one embodiment of the present invention, the business process and management components 24 provide a loan financial orchestration interface 81 for combining a number to smaller fund requirements in order to satisfy a larger loan.

In one embodiment, the loan financial orchestration interface 81 is adapted to generate each and every combination of borrower tender data in order to find a list of best borrows for the loan. However, this method is an extremely resource intensive task and may not even be feasible. In another embodiment, the loan financial orchestration is generated by the support vector machine or deep neural network of the intelligent contents analyser 74. The loan financial orchestration interface 81 may generate mock-up loan financial orchestration to lenders for training. Together with the previous approved loan financial orchestration data, the loan financial orchestration interface 81 can train up the support vector machine or deep neural network of the intelligent contents analyser 74, such that a new loan financial orchestration can be generated efficiently using the intelligent contents analyser 74.

By using the support vector machine and deep neural network of the intelligent content analyser 74, the properties of the borrower portfolio may not fully satisfy the criteria of one or more the lenders. The loan financial orchestration interface 81 is adapted to highlight the non-compliance properties of the borrower portfolio and alert the borrower and lenders. In one embodiment, the loan financial orchestration interface 81 may rank the different syndicate by the probability of successful expectation. The borrower may then adjust the loan requirements or the lenders may adjust the criteria.

In yet another embodiment of the present invention, the loan financial orchestration interface 81 is adapted to receiving one or more borrower combinations from the lender directly. The loan financial orchestration interface 81 will verify the lender criteria and alert the borrower for non-compliance property.

The loan syndication interface 82 allows users to engage in the process of funding various portions of a loan for a single borrower. In an event that the borrower and the lender matching interface tails to find a matching pairs due to the borrower's fund is outside the range of a single lender's risk exposure levels, the financial server 16 of the present invention is adapted to provide a loan syndication interface 82 to search for multiple lenders to form a syndicate to provide the borrower with the requested fund.

In one embodiment, the loan syndicate interface 82 is adapted to generate each and every combination of lenders proposal data in order to find a list of best syndication for the loan. However, this method is an extremely resource intensive task and may not even be feasible. In another embodiment, the loan syndicate Is generated by the support vector machine or deep neural network of the intelligent contents analyser 74. The loan syndicate interface 82 may generate mock-up loan syndication to lenders for training. Together with the previous approved syndicated data, the loan syndicate interface 82 can train up the support vector machine or deep neural network of the intelligent contents analyser 74, such that a new loan syndicate can be generated efficiently using the intelligent contents analyser 74.

By using the support vector machine and deep neural network of the intelligent content analyser 74, the properties of the borrower portfolio may not fully satisfy the criteria of one or more the lenders. The loan syndicate interface 82 is adapted to highlight the non-compliance properties of the borrower portfolio and alert the borrower and lenders. In one embodiment, the loan syndicate interface may rank the different syndicate by the probability of successful expectation. The borrower may adjust the loan requirements or the lenders may adjust the criteria.

In yet another embodiment of the present invention, the loan syndicate interface 82 is adapted to receiving one or more lender combinations from the borrower directly. The loan syndicate interface 82 will verify the lender criteria and alert the borrower for non-compliance property.

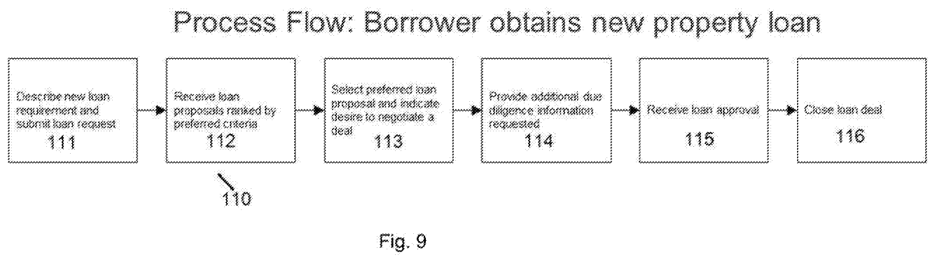

Reference to FIG. 9, there is provided a method of a borrower to obtain a new property loan 110 of an embodiment of the present invention. The method comprising the steps of: Specifying a new loan requirement and submit a debt tender through the borrower portal 85 in step 111, wherein the loan requirement comprises one or more of a fund, a property, property owner, existing debt, and lease; Receiving loan proposals ranked by preferred criteria in step 112; Selecting a preferred loan proposal and indicate a desire to negotiate a deal in step 113; Providing additional due diligence information requested in step 114; Receive one or more loan offer in step 115; and Closing a loan deal in step 116.

In one embodiment, the step of specifying a new loan requirement 111 involves the specify fund function 41, specify property function 42, assign property ownership function 43, specify existing debt function 44, and specifying lease function 45 accessible from the borrower portal 85. The submission of debt tender proposal step 111 may involve the view investment portfolio function 46, the run portfolio investment scenario function 47, and submit debt tender function 48.

The step of selecting preferred loan proposal 113 may involve the compare debt tender proposals 49. The step of providing additional due diligence information requested 114 may involve the provide tender due diligence information 50. The step of closing a loan deal 116 may involve the accept debt tender proposal function 51 and any of the request service function 52, compare service proposal function 53, and accept service proposal function 54.

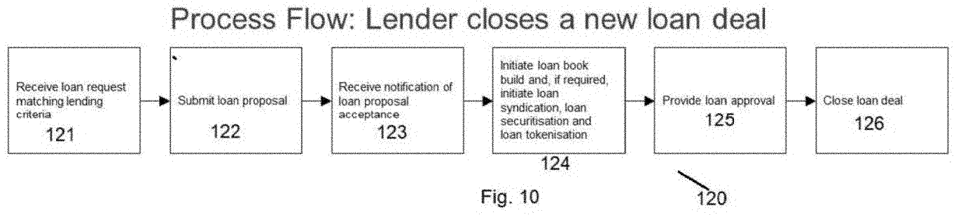

Reference to FIG. 10, there is provided a method of a lender to close a new deal 120 of an embodiment of the present invention. The method comprising the steps of: Receiving loan request or debt tender matching lending criteria in step 121; Submitting loan proposal in step 122; Receiving notification of loan proposal acceptance in step 123; Initiating loan book build and, if required, initialing loan syndication, loan securitisation and loan tokenization in step 124; Providing loan approval in step 125; Closing loan deal in step 126.

In one embodiment of the present invention, the lender many access the lender portal 86 to access the specify the lending criteria function 55. When a borrower submits a debt tender, the financial server 16 may invoke the borrower and lending matching interface 80, the loan financial orchestration interface 81, and/or the loan syndicate interface 82 to find the potential lenders. The borrower may liven update their debt tender and submit to the lender through the borrower portal 85. From there, the lender will receive loan request or debt tender matching lending criteria in step 121.

In Submitting loan proposal in step 122; the lender may use the lender portal 86 rendered on the user device 101 to access the submit debt proposal function, live lender may also use the lender portal 86 to access the view debt tender function 56, identify property function 58, identify owners of the property's legal entity function 69, and view property value function 61. The lender may also use the lender portal 86 to request further tender due diligence information from a borrower with the request tender due diligence information function 63.

The Initiating loan book build and, if required, initiating loan syndication, loan securitisation and loan tokenization in step 124 may involve the use of the loan syndicate interface 82, and loan tokenization interface 83 for accessing the securitise and tokenise loan function 66. The providing loan approval in step 125 may involve the make loan offer function 65 and the closing loan deal in step 126 may involve the initiate closing function 66.

Examples of the implementation of the electronic system 10 is described as follows.

### Scenario 1: From a Borrower's Perspective—Borrower Obtains New Property Loan for a Small Commercial Property Loan of $10 Million

A mortgagor or borrower access the borrower portal 85 on a user device 101 to specify new loan requirements and submits loan requestor debt tender request.

The mortgagor does this by creating a property loan request on the electronic system 10 where the mortgagor specifics information about the loan requirements and the property that the loan request relates to. This information provided by the mortgagor is required by prospective mortgagees or lenders to decide whether the mortgagees will put forward an initial loan proposal or debt tender in response to the mortgagor's loan request through the lender portal 86.

The information may include the property address, the property type (e.g. office building, a shopping centre, an industrial complex), the class of building (e.g. class A, B, C or D), the size of loan ($10 million in this scenario), the value of the building and the purpose of the loan (e.g. refinance, property development). The schema of the property and related data is adapted to accommodate these attributes.

Once the mortgagor has provided the information required for the loan request, they submit their loan request or debt tender through the borrower portal 85 on the user device 101.

The borrower portal 85 passes the loan request or debt tender to the financial server 16 of the electronic system 10, which invokes one of the “borrower and lender matching” algorithm and matches the borrowers loan requirements with the lending criteria of the mortgagees registered on the system and notifies those matching mortgagees of the loan request. The “borrower and lender matching” algorithm is carried out by the three major interfaces—the borrower and lender matching interface 80, the loan financial orchestration interface 81, and loan syndicate interface 82 of the business process and management components 24 of the financial server 16.

The lending criteria of each mortgagee may include criteria such as upper and lower loan size, the maximum loan-to-value ratio, the loan purpose and the acceptable property location (e.g. cities covered by the mortgagee), property type and class of building (e.g. they may not lend money for buildings that arc class C or D which arc typically older and less well maintained than a class A or B building). In one embodiment, the lender may also specify the priority of the criteria and the acceptance tolerant range of the criteria.

The matching mortgagees have the option to then review the matching loan request and submit a loan proposal on the system with the details of their offer including information such as a proposed interest rate and proposed term of the loan (e.g. 5 years).

Mortgagor will receive debt tenders ranked by preferred criteria. The debt tenders can be view by a lender on the lender portal 86 rendered on a user device 101.

The mortgagors can review and compare the loan proposals or debt tender proposals they have received through the borrower portal 85 and rank them according to their preferred criteria such as the proposed interest rate, proposed fees to be charged by the mortgagee and proposed term of the loan. The borrower portal 85 also is adapted to indicate which of the loan proposal or debt lender proposal attributes differ, and in what way. from the criteria of those attributes the mortgagor specified with the specify lending criteria function 55 (e.g. the loan term proposed by the mortgagee may be longer than the loan term requested by the mortgagor).

A mortgagor selects preferred debt tender proposal through the borrower portal 85 on the user device 101. The mortgagor may signal the lender lo negotiate a loan deal through the chat collaboration interface 89 in real time or offline.

A notification regarding the mortgagor's acceptance of the mortgagee's loan proposal or debt tender to the mortgagee via financial server 16 and one or more preferred communication means such as email or SMS. The mortgagee can also see the loan proposal acceptance notification on the lender portal 86.

The mortgagee may invoke the request due diligence information 62 on the lender portal 86 and the mortgagor may provide additional tender due diligence information with the provide tender due diligence information function 50 provided by the borrower portal 85.

The financial server 16 is adapted to initiate automated steps in the loan application process in the event that the financial server 16 signals the mortgagor to provide additional information required by a mortgagee to conduct their due diligence. A default checklist of information required for this due diligence (e.g. the property title, list of tenants in the building, tenant lease revenue information, environmental report) is provided by the intelligent document composer interface 75 of the core service management components 22. However, the mortgagee may control the access items on this list by authorising the access the only information required. This novel approach further streamlines the loan process, reducing the time to complete a loan and reducing the likelihood of disruption to the loan process.

In one embodiment, the financial server 16 will decrypt the access control document and information, copy the decrypt information and document to a temporary storage, generate one or more session keys, encrypt the access control document and information with the session keys, and distribute the session keys for the authorised parties to access the authorised document or information. The temporary storage will be cleaned out periodically such that the session keys will render useless after the expiration period.

In addition, in the case where the mortgagor has already used the electronic system 10 before and has already loaded on the electronic system information regarding the property associated with the loan proposal or debt tender proposal (e.g. details regarding the property, its tenants, financial and commercial information, current and previous loan history), the intelligent document composer interface 75 may update and reuse the information as a source of the due diligence information required by the mortgagee.

The government and industry interface adaptors 91 of the electronic system 10 is able to integrate with the mortgagor's property accounting and tenant lease management systems ensuring that that financial, commercial, tenant and lease information is kept up to date on the system, further reducing the time and streamlining the process for the mortgagor to provide the necessary due diligence information.

As part of the overall novel loan application and processing workflow, the borrower portal 85 provides various Junctions mentioned above for the mortgagee to monitor what due diligence related information has been provided so far and is notified by the system when the mortgagor has provided all of the necessary information. The borrower portal 85 also provides the functions for the mortgagee to communicate offline or in real time with the mortgagor via a secure audited online chat facility (communicating with the mortgagor via text, audio or video) via the chat collaboration interface 89. The mortgagor can also use this hat collaboration interface 89 to ask the mortgagee any questions they may have.

The lender portal 86 of the present invention is adapted to provide a confirm credit underwriting decision to a mortgagee to complete the underwriting review of the loan request. The completion of the underwriting review may involve the mortgagee requesting other third parties, such as property valuers, site engineers and lawyers to perform necessary review work and to provide their findings via the government and industry interface adaptors 91.

The novel streamlined underwriting workflow provided by the electronic system 10 includes the ability for the mortgagee to find a suitable third party service provider via an integrated service provider marketplace facility and to invite their chosen their party service provider into the specific loan proposal underwriting process giving the service provider convenient and secure access to the information they require to conduct their review and to record their findings.

Once the mortgagee is satisfied they are prepared to agree with the loan deal with the mortgagor, the mortgagee may signal the electronic system 10 of the decision to carry out the mortgagor receives loan approval procedures.

In the mortgagor receives loan approval procedures, the financial server 16 of the present invention is adapted to send the mortgagor a notification indicating that the mortgagee has approved the loan and provides the mortgagor with relevant information in preparation for closing the loan deal with the mortgagee.

The financial server 16 will then automatically prepare the resources for the mortgagor and mortgagee to close a loan deal.

The financial server 16 is adapted to generate a checklist of loan closing instructions or business rules for both the mortgagor and mortgagee with the initiate closing function 65. This checklist includes the digitation execution of closing documents using the intelligent document composer interface 75. As such, the financial server 16 may further streamline the end to end loan establishment process by dynamically generating a number of the closing documents and allowing these documents to be digitally signed. In one embodiment, the executed document will be stored to the distributed ledger immediate to prevent tampering.

### Scenario 2: From a Borrower's Perspective—Borrower Obtains New Property Loan for a Large Commercial Property Loan of $500 Million

In this scenario, the mortgagor specifies new loan requirement and submits a loan request to the financial server 16 through the borrower portal 85.

The borrower portal 85 provides an interface for a mortgagor create a property loan request on the electronic system 10 where the mortgagor may specify information about their loan requirements and the property that the loan request relates to. Once the mortgagor has submitted the information required for the loan request to the financial server 16, tire financial server 16 w ill then accept the loan request from the mortgagor.

The financial server 16 is adapted to pass the loan request to a “borrower and lender matching” algorithm using the borrower and lender matching interface 80 which matches the borrower's loan requirements with the lending criteria of the lenders registered on the financial server. When the financial server 16 determines that there are no currently debt tender proposal or registered mortgagees who can service the full amount of the loan independently and that a syndicate of mortgagees will be required to service the whole loan whereby each party mortgagee to that syndicate will fulfil a portion of the loan. For example, 5 mortgagees may be required with each mortgagee contributing $100 million to make up the full $500 million required for this example loan. Such a loan involving a syndicate of mortgagees is referred to as a syndicated loan. The financial server 16 is adapted to signal the mortgagor that no single mortgagee can fulfil their loan request and that a syndicated loan is required.

In the ease of a syndicated loan, one of the mortgages is typically assigned a coordination role, known as a bookrunner, in arranging the syndicate loan through a process typically referred to as a bookbuilding process. The financial server 16 of the present invention provides a novel approach to handling syndicated loan by giving the ability to the mortgagee to play the role of the bookrunner with the automated bookbuilding process or loan syndicate process using the loan syndicate interface 82.

The loan syndicate process or bookbuilding process involves finding a plurality of mortgagees or lenders with loan selection criteria profiles that best match the mortgagor's loan request and where the mortgagee loan selection criteria indicate they are prepared to be a mortgagee party to a syndicated loan. In one embodiment, this group of matching mortgagees is presented by the financial server 16 to the mortgagor. The mortgagor then selects the preferred mortgagee group via the borrower portal 85 interface provided by the electronic system 10 and is shown what portion of their loan is satisfied as they select each mortgagee.

In one embodiment, the loan syndicate may carry out the method comprising the steps of: evenly distribute the total amount of the loan across the chosen mortgagees but not allocate to any one mortgagee an amount greater than the maximum loan size the mortgagee may have indicated on their lending profile on the data storage 14; and selecting sufficient mortgagees to cover the full amount of the loan, the system indicates to the mortgagor that 100% of the loan amount can be fulfilled.

The mortgagor may submit their syndicated loan request via the borrower portal 85 and the financial server 16 will then notify the selected candidate syndicated loan mortgagees of the syndicated loan request.

The matching mortgagees have the option to then review the matching loan request, the portion of the loan allocated, the names and profiles of the other candidate syndicated loan mortgagees as well as the portion of loan allocated via the lender portal 86. If each mortgagee is satisfied with the loan request details and is prepared to be a party to that specific syndicate of mortgagees, the mortgagee may submit a loan proposal or debt tender proposal with the details of the offer including information such as a proposed interest rate and proposed term of the loan (e.g. 5 years).

The mortgagor will then receive loan proposals or ranked by preferred criteria.

The mortgagor can review and compare be syndicated loan proposals they have received on the financial server 16 and rank proposals according to their preferred criteria such as the proposed weighted average interest rate, proposed weighted average fees to be charged and proposed term of the loan. The compare debt tender proposal function 49 also indicates to the mortgagor which of the loan proposal attributes differ, and in what way, from the desired attributes the mortgagor indicated in their loan request.

If the debt tender proposals from either of the syndicate mortgagees offer a loan amount different to that requested, this is indicated by the system to the mortgagor, including if the total loan amount on offer no longer satisfies the total required amount and the financial server 16 is adapted to give the mortgagee several options such as requesting either of the mortgagees to vary the loan amount on their respective proposal or selecting a new candidate mortgagee to add to the syndicate. Any addition or removal of a mortgagee from the syndicate is flagged to the other syndicate mortgagee parties.

The borrower portal 85 is adapted to allow a mortgagor to select the preferred loan proposal or debt tender proposal and initiate a communication channel via the chat collaboration interface 89 to negotiate a loan deal offline or in real time. In one embodiment, the communication channel is secured with data encryption.

The borrower portal 85 is adapted to allow a mortgagor to select one or more of the loan proposals t received and establish a secured communication channel via the chat collaboration interface 89 to negotiate a loan deal with the mortgagee syndicates that submitted each of the selected loan proposals.

The financial server 16 is adapted to send a notification regarding the mortgagor's acceptance of the syndicate's loan proposal or debt tender proposal to the mortgagees via the preferred communication means such as email or SMS. The mortgagee can also sec the loan proposal acceptance notification on the lender portal 86.

The borrower portal 86 is adapted to allow a mortgagor provides additional due diligence information requested with the provide tender due diligence information function 50.

The electronic system 10 of an embodiment of the present invention initiates automated steps in the loan application process whereby the mortgagor is signaled by the financial server 16 to provide additional information required by each of the syndicate mortgagees to conduct their due diligence.

A default checklist of information required for this due diligence (e.g. the property title, list of tenants in the building, tenant lease revenue information, environmental report) is provided by the intelligent document composer interface 75 of the core service management components 22. However, the mortgagee may control the access items on this list by authorising the access the only information required. This novel approach further streamlines the loan process, reducing the time to complete a loan and reducing the likelihood of disruption to the loan process.

Once the syndicate mortgagees' criteria are satisfied, the lender portal 86 is adapted to allow the mortgagees to compile a loan deal agreement with the mortgagor with the intelligent document composer interface 75. The mortgagees may send notifications to indicate the loan approval to the financial server 16 which is adapted to alert the mortgagor. The borrower portal 85 is adapted to allow the mortgagor to track which syndicate mortgagees have approved their respective loan.

The borrower portal 85 is also adapted to allow the mortgagor to receive loan approval. The mortgagor may receive a notification sent from the financial server 16 indicating that all of the syndicate mortgagees have approved the loan. The borrower portal 85 provides the mortgagor with relevant information in preparation for closing the loan deal with the syndicate mortgagees.

The financial server 16 will then automatically prepare the resources for the mortgagor and syndicate mortgagees to close a loan deal.

The financial server 16 is adapted to generate a checklist of loan closing instructions or business rules for both the mortgagor and syndicate mortgagees with the initiate closing function 65. This checklist includes the digitation execution of closing documents using the intelligent document composer interface 75. As such, the financial server 16 may further streamline the end to end loan establishment process by dynamically generating a number of the closing documents and allowing these documents to be digitally signed. In one embodiment, the executed document will be stored to the distributed ledger immediate to prevent tampering.

In one embodiment of the present invention, the financial server 16 is specifically design tor lending money for commercial property. Commercial loan amounts are normally much larger. Hence, approving a commercial loan requires supporting documentation that is more complex to construct with more elements to it. Lot more information is required for the application process of a commercial loan than that of a residential loan. There arc more types/categories of information required for a commercial loan and the application process (e.g. who are the tenants, what are their lease details, when do leases expire etc) as the lender (or lenders) involved wants to work out there is sufficient rental money coming in to pay for the loan interest and all other bills that that the commercial property owner needs to pay to run the building.

Commercial loans usually involve commercial entities as owners rather than not private individual persons. Commercial loans can relate to one or more buildings (residential loans normally relate to one building). Commercial loans involve multiple lenders financing the one loan—this is known as a syndicated commercial property loan (residential loans normally involve one lender). The commercial loan application process is more complex and takes longer

Any commercial loan application and processing systems therefore need to be much more sophisticated to support these requirements compared to a residential loan application and processing system.

Although the invention has been described with reference to specific examples, it will be appreciated by those skilled in the art that the invention may be embodied in many other forms, in keeping with the broad principles and the spirit of the invention described herein.

The present invention and the described preferred embodiments specifically include at least one feature that is industrial applicable.

While the invention has been disclosed in con junction with a description of certain embodiments, including those that arc currently believed to be the preferred embodiments, the detailed description is intended to be illustrative and should not be understood to limit the scope of the present disclosure. As would be understood by one of ordinary skill in the art. embodiments other than those described in detail herein are encompassed by the present invention. Modifications and variations of the described embodiments may be made without departing from the spirit and scope of the invention.

It will further be understood that any of the ranges, values, properties, or characteristics given for any single component of the present disclosure can be used interchangeably with any ranges, values, properties, or characteristics given for any of the other components of the disclosure, where compatible, to form an embodiment having defined values for each of the components, as given herein throughout. Further, ranges provided for a genus or a category can also be applied to species within the genus or members of the category unless otherwise noted. Finally, the qualifier “generally,” and similar qualifiers as used in the present case, would be understood by one of ordinary skill in the art to accommodate recognizable attempts to conform a device to the qualified term, which may nevertheless fall short of doing so. This is because terms such as “cylinder” are purely geometric constructs and no real-world component is a true “cylinder” in the geometric sense. Variations from geometric and mathematical descriptions are unavoidable due to, among other things, manufacturing tolerances resulting in shape variations, defects and imperfections, non-uniform thermal expansion, and natural wear. Moreover, there exists for every object a level of magnification at which geometric and mathematical descriptors fail due to the nature of matter. One of ordinary skill would thus understand the term “generally” and relationships contemplated herein regardless of the inclusion of such qualifiers to include a range of variations from the literal geometric meaning of the term in view of these and other considerations.

1. A method of recording a loan deal in a remote electronic database of an electronic system, comprising the step of:
specifying a new loan requirement and submit a debt tender through a borrower portal interface rendered on a user device to a financial server;
receiving one or more digital documents to the financial server, storing an encrypted copy of the digital documents in the remote database, and a digital signature of the digital document on a distributed ledger;
generating a list of loan proposals from the loan proposals stored in the remote database and ranking the loan proposals on the list by one or more criteria;
selecting a preferred loan proposal from the list of loan proposals on the user device;
providing a digital access credential to access a subset of the digital documents;
compiling a digital loan offer for accepting on a user device; and
storing an accepted digital loan offer in the remote database and a digital signature of the accepted digital loan offer on a distributed ledger.

2. A method according to claim 1, wherein the subset of digital documents comprises digital documents required by a lender to perform due diligence in assessing the loan proposal.

3. A method according to claim 2, wherein the financial server comprises a government and industrial interface adaptor associated with a third party database management system for retrieving authenticated documents from a third party database.

4. A method according to claim 3, wherein the distributed ledge comprises a blockchain data structure having for storing the digital signature of the documents.

5. A method according to claim 4, wherein digital access credential comprises one or more temporary session keys for decrypting the documents.

6. A method according to claim 5, wherein the government and industrial interface adaptor is adapted to periodically verify and update the documents.

7. A method according to claim 6, wherein loan deal comprises one or more smart contracts to facilitate settlement transactions.

8. A method according to claim 7, wherein the loan requirement comprises one or more of a debt entity, a fund entity, a property entity, property owner entity, existing debt entity, and lease entity.

9. A method according to claim 8, wherein the criteria has a set range to the one or more entities.

10. A method for according to claim 9, wherein the step of generating a list of loan proposals comprises the steps of:
extracting a loan amount attribute from a fund entity of the loan requirement;
comparing the loan amount with the criteria of a loan proposal;
in the event the loan amount is within the set range of a fund criterion, comparing other entities and corresponding criteria;
in the event the other entities are within the set range of the corresponding criteria, record the loan proposal on the list of loan proposals.

11. A method according to claim 10, wherein in the event that the loan amount is above the set range of a fund criterion, the financial server is adapted to generate a loan syndicate with a plurality of loan proposals with an aggregated loan amount equal to the loan amount of the loan request.

12. A method according to claim 11, wherein each of the plurality of loan proposals of the loan syndicate has a same value in the loan amount.

13. A method according to claim 12, wherein the financial server comprises a support vector machine for analyzing information from the remote database to generate one or more loan syndicate fora loan requirement.

14. A method according to claim 10, wherein in the event that the loan amount is above the set range of a fund criterion, the financial server is adapted to generate a loan financing orchestration having a plurality of loan requirements with an aggregated loan amount equal to that loan amount of the loan proposal.

15. A method according to claim 14, wherein the financial server comprises a support vector machine for analyzing information from the remote database to generate one or more loan financing orchestration for a loan proposal.

16. A method according to claim 1, further comprising the step of recording a service provider arrangement for the loan deal in the remote database.

17. A method according to claim 16, wherein the financial server is adapted to securitise a loan deal into a plurality of asset-back securities, store the asset-back security in the remote database, and a digital signature of the asset-backed security on a distributed ledger.

18. A method according to claim 17, where the financial server is adapted to provide a chat collaboration interface for users to communicate offline and in real time via an encrypted data channel.

19. A user device connecting to a financial server comprising one or more processing unit in communication with each other to execute a method comprising the steps of:
receiving a loan request matching lending criteria from the financial server;
submitting a loan proposal to the financial server;
receiving notification of loan proposal acceptance from the server;
initiating loan book build and, if required, initiating loan syndication, loan securitisation and loan tokenization, wherein the loan syndication comprises a plurality of loan proposal having an aggregated loan amount equal to the loan amount of the loan request;
providing loan approval;
closing loan deal wherein the loan deal is recorded in a remote database and the digital signature of the loan deal is record on a distributed ledger.

20. A user device of claim 19, further comprising the steps of compiling a list of required documents for due diligent, requesting the financial server for an access credential for the list of required documents, and using the access credential to retrieve the list of required documents from the remote database.
